(19) United States
(12) Patent Application Publication
(10) Pub. No.: US 2020/0053965 A1
(43) Pub. Date: Feb. 20, 2020

(54) Build Your Own Array

(71) Applicant: Anthony Peter Tran, Los Gatos, CA (US)

(72) Inventor: Anthony Peter Tran, San Jose, CA (US)

(73) Assignee: Tcube Technologies Inc., Los Gatos, CA (US)

(21) Appl. No.: 15/660,872

(22) Filed: Aug. 16, 2018

(51) Int. Cl. A01G 7/04; H05B 33/08; H05B 37/02; F21V 29/74

(52) U.S. Cl. CPC A01G 7/045; H05B 33/0857; F21V 29/60; F21V 29/74; H05B 37/0272

(57) ABSTRACT

Systems connect enables setup for the system's interconnection by detecting and controlling which devices are master(s) and which are slave(s), and can control The photosynthesis wavelength controller enables manual or wi-fi control over LED lights to enhance photosynthesis of each and you can build your own array.

### CROSS REFERENCE TO RELATED APPLICATIONS

YES: [See: Wavelength Controller patent no 15586232; CBD wavelength enhanced plant application 29603566, trademark application for name “Grow Warrior LED” 87324673 trademark application for “Build You Own Array” 87446030; “Photosynthesis wavelength controller no. 87448259.

### STATEMENT OF FEDERALLY SPONSORED RESEARCH/DEVELOPMENT

Not applicable.

### REFERENCES

Not applicable.

### BACKGROUND OF THE INVENTION

I am an electrical engineer. I designed products used bylaw enforcement including a breath analyzer and radar gun, (See Trial Exhibit 61). Mr. Andre La Forge and I decided to start a business Apache Technology LLC (“Apache”) to make and sell LED lights that could be used for growing plants. I was in charge of technology and deposited the schematics and data with Apache Technology LLC. The lights were purchased on multiple occasions NASA and Stanford University. Mr. La Forge shut down the company (Ex 81) never shared any of the profits and took the technology in favor his unbeknownst like sounding company Apache Tech Inc. The Apache Tech Inc lights use the same design, and lens which are molded with “patent pending” on them, something La Forge testified he did to scare away competition, (See Judgment; and Exhibit ______. photo of the improper marking “patent pending.” I have been in litigation the past 5 years with another 5 years on the horizon. This made me realize, the only way I win my life back is to fight, and fight by designing a new different and better LED light, with a different PCB and lens with 6×10 rows.

There is a need for the ‘Build your own array’ master/client connected network of adjustable wavelength controlled array which can be built into customized geometric shapes, lines or designs, including flexible heights and angulations, to most efficiently cover an area with necessary light and best wavelength, most efficiently for maximum photosynthesis, propagation, with memory data storing for plant branding and duplicating customized wavelength.

### BRIEF SUMMARY OF THE INVENTION

Each The LED light can be fully operated manually, via network cloud, phone and/or computer, to have control over the wavelength adjustivity to enhance photosynthesis. (Photosynthetically active radiation) or connect in daisy chain to hanged or sit on the rail rack 4 feet×8 inch width rack or 4 feet×4 feet square with 8 inch width all Tack can be add to be 8 foot or 12 ect., and the width a1 can be adjust to be 4 inch for other Led Light have the width 4 inch. Each Led Light connect together to in and out power, RJ11 communications port to be master or slave. Each Led Light have: Heat sink, Heat sink cover, Light cover, Light base.

### BRIEF DESCRIPTION OF THE SEVERAL VIEWS OF THE DRAWING

The parent controller controls several components (timer, LCD, temperature sensor, switch, system memory, light bulb pattern, wave light circuitry, wave length controller, internal light meter, computer interface, system interface, network interface) via wi-fi through several devices (external light meter, computer, system connection, cloud network.).

### DETAILED DESCRIPTION OF THE INVENTION

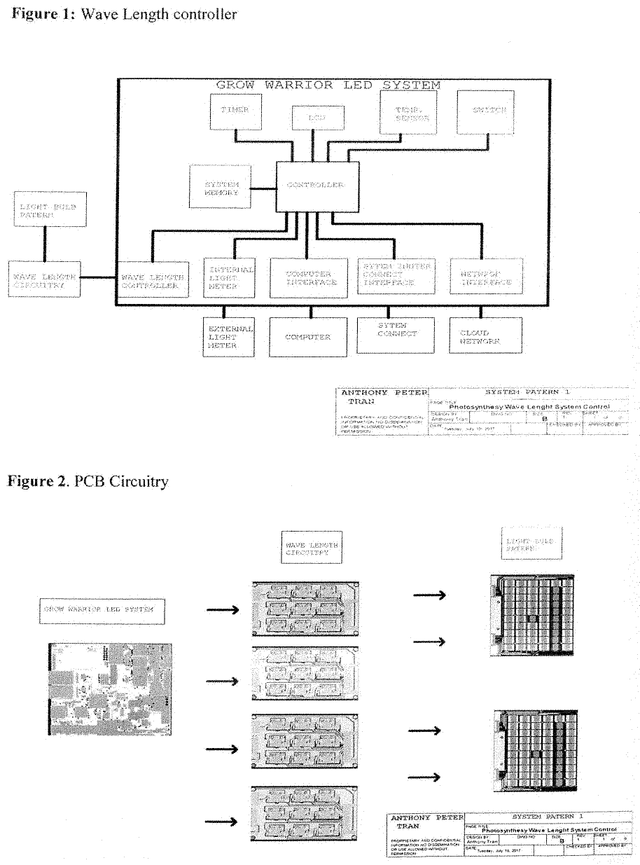

### System Control Description: (FIG. 1 and FIG. 2)

Temperature: The system measures temperatures within the system to make control decisions over the system.

Timer: The timer sets up events needed for photosynthesis scheduled for each day and each hour.

LCD: The LCD displays the event to occur and orders the action.

Switch: The switch gives the owner the choice to set up the schedule manually.

System memory: The system memory stores data for all events.

Software and hardware control all peripheral input/output and wave length.

Systems light meter: The systems light meter enables reports on the light, and photosynthetically active radiation and photosynthesis wave length control.

Photosynthesis is controlled by pulse width modulations for lamda wave length and enables control of the light blossom and veggie and ocean modes.

### Photosynthesis Wave Length Control

The photosynthesis wave length control enables manual or network control of photo synthetically active radiation, often abbreviated PAR. It designates the spectral range (wave band) of solar radiation from 400 to 700 nanometers that enable photosynthesis.

Energy control wavelength is made by PWM (Pule Width Modulation).

### Light Bulb Pattern

This light bulb patter used in RGB technology. It will control ROW pattern and it Row will be any photosynthesis wave length.

### Networks Control

The system operates with either with manual setting or with a network interface with WWI or wire network to control the light system through the network cloud and setup the wave length, veggie, blossom, or ocean modes.

### Systems Connect

Systems connect enables setup for the system's interconnection by detecting and controlling which devices are master(s) and which are slave(s).

### Computer Interface

The computer interface enables connection to a computer to report all events occurred in the system.

### Light Meter

The light meter enables internal or external measurement of the photosynthetic photon flux (PAR) in common radiation sources with a spectra radiometer in values in μmol.

### Event Flow

The system is operated manually or via network cloud, phone and/or computer, to control photo synthetically active radiation, often abbreviated PAR. It designates the spectral range (wave band) of solar radiation from 400 to 700 nanometers that photosynthetic organisms are able to use in the process of photosynthesis. This spectral region corresponds to the range of light visible to the human eye. indeed, photons at shorter wavelengths tend to be so energetic that they can be damaging to cells and tissues, but are mostly filtered out by the ozone layer in the stratosphere. Photons at longer wavelengths do not carry enough energy to allow photosynthesis to take place.

Thesystems can set up light photosynthesis in any color mode for each row of lights by modifying PAR (photosynthetic photon flux) values in μmol/s, which can be modified by applying different weighting factors to different wavelengths. Day schedules and photosynthesis can be setup manually in the timer. The system memory can also store all the data and all the events occurrences, including each day, month, and year. The end-user can setup on which day he or she wants the event to occur. For example, the end-user can setup photosynthesis in veggie mode to occur within the next five days and the following five days to be in blossom mode, or vice versa. The end-user can also see LCD display or computer hookup.

All the events above can be controlled via networks cloud, WiFi, Ethernet networks, or Cell phone.

### Mechanical Led Light Box

Each Led light box had 4 sections:
Light cover
Light Base
Fan Cover or Fan Support.
Heat Sink use sheet metal aluminum technology to build a heat sink: Heat sink plate and heat sink fin.

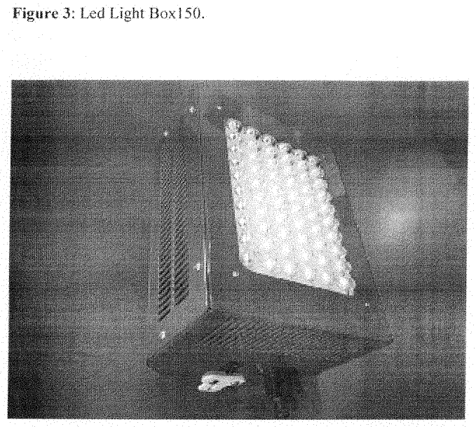

### Led Light Box 150 Mechanical Draw (FIG. 3).

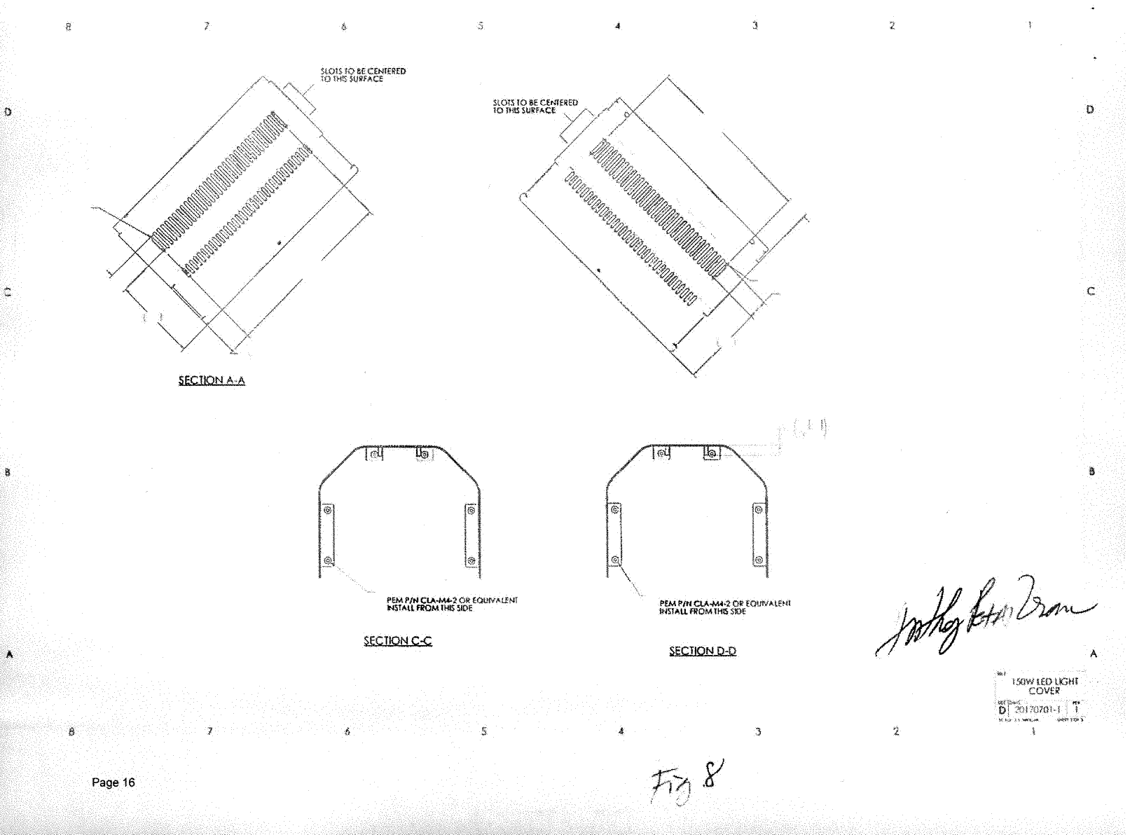

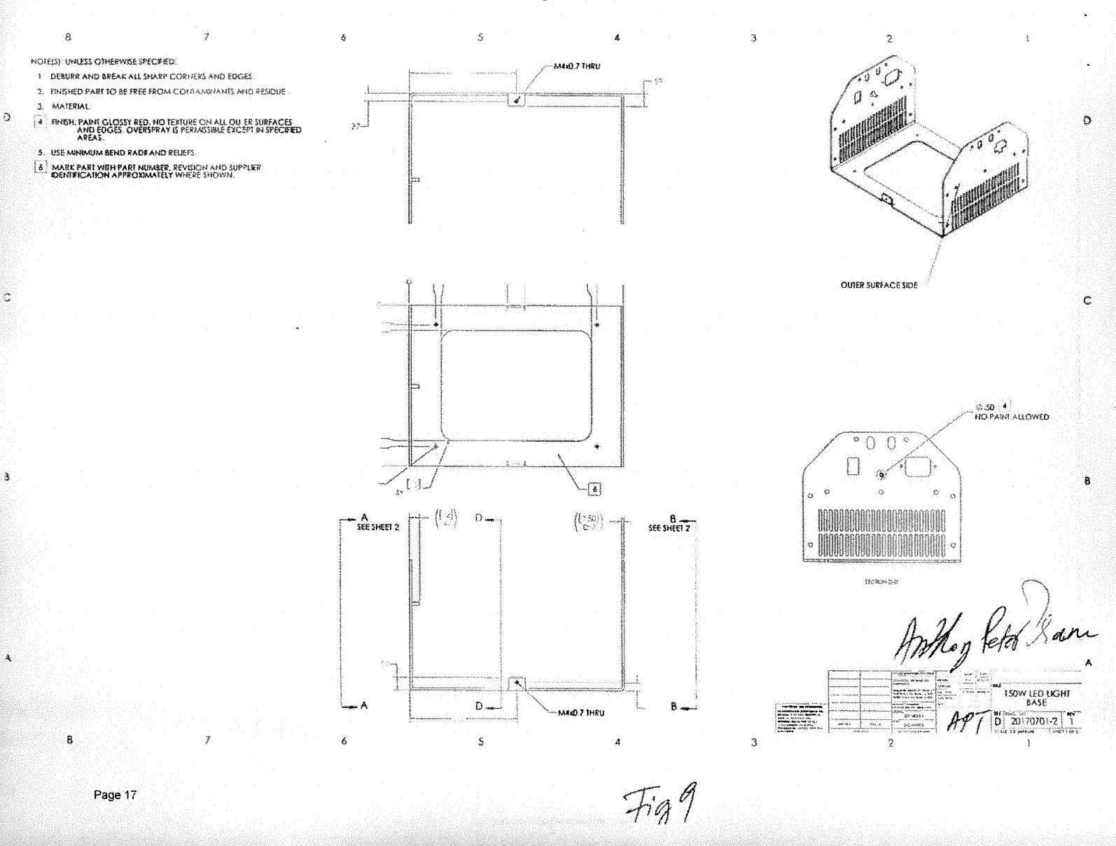

i. Light cover FIG. 7 and FIG. 8

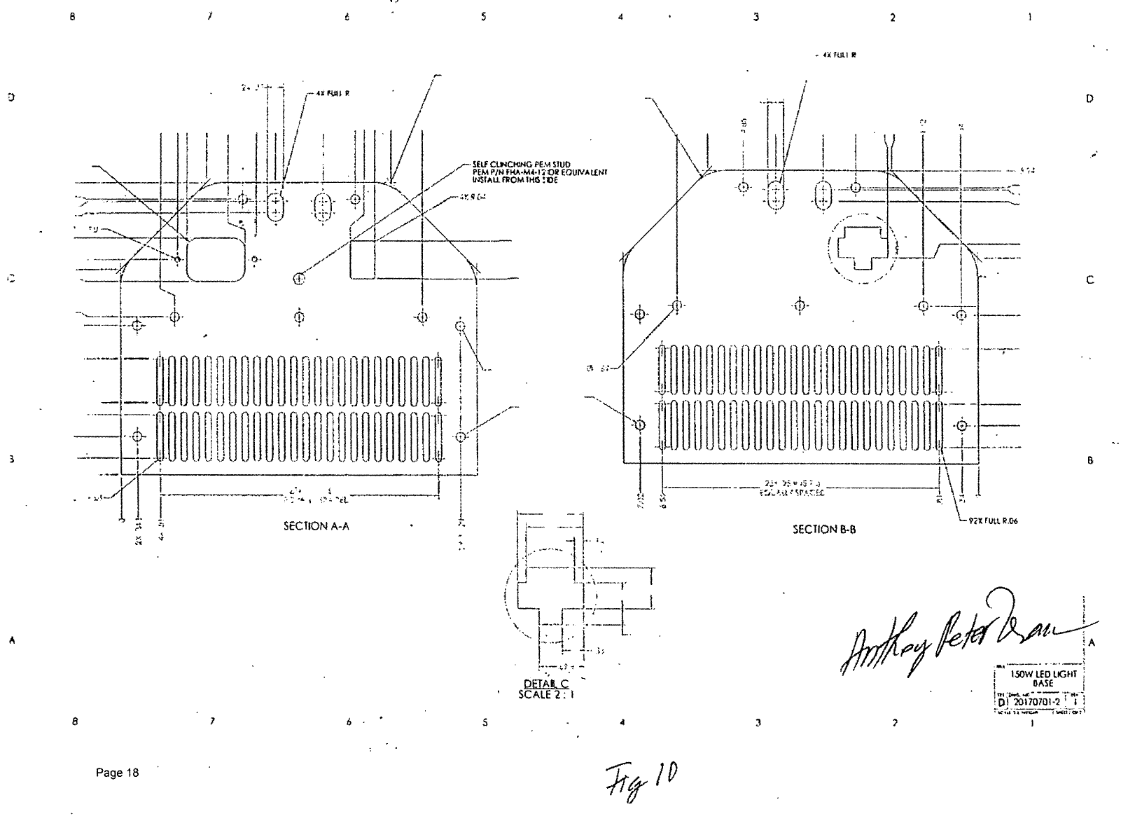

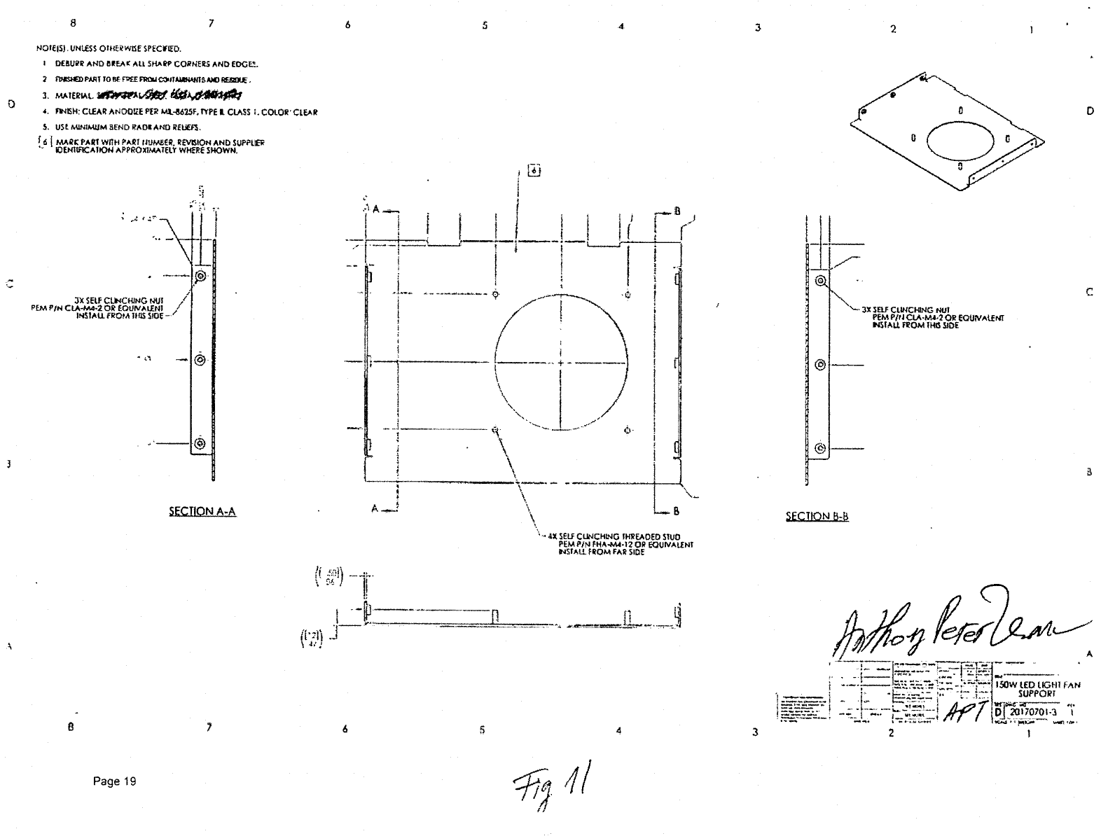

ii. Light Base FIG. 9 and FIG. 10

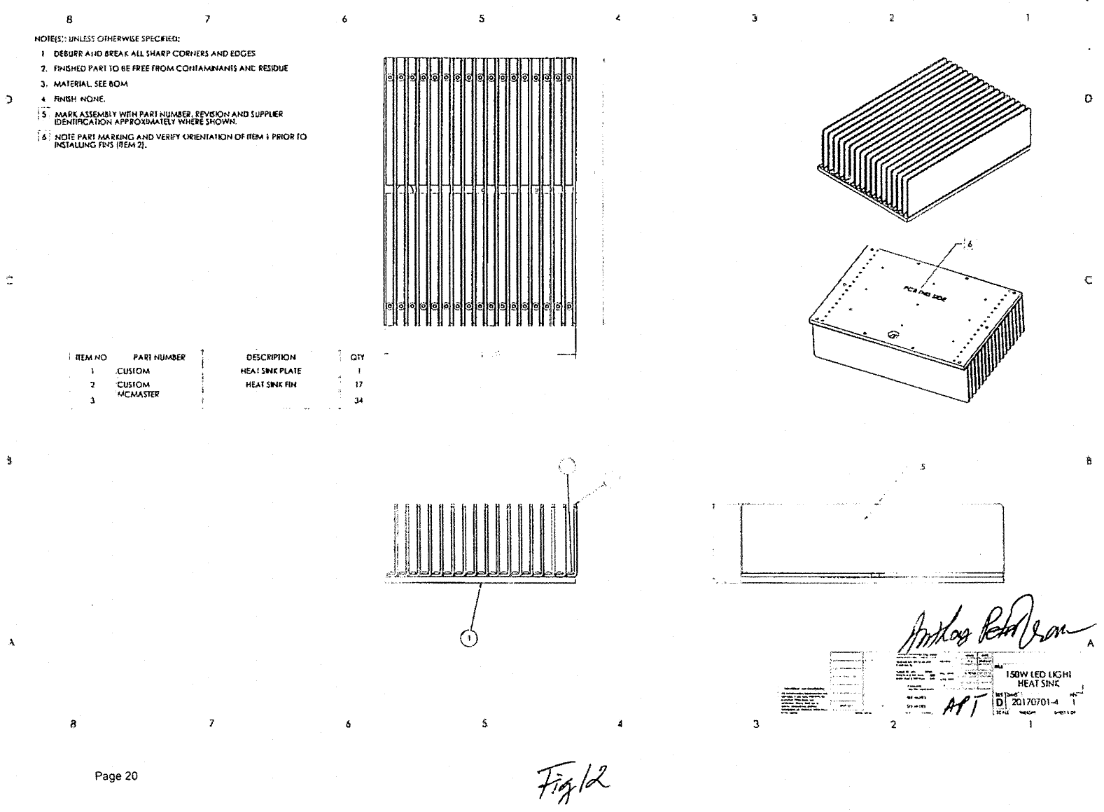

iii. Fan Cover or Fan Support. (FIG. 11)

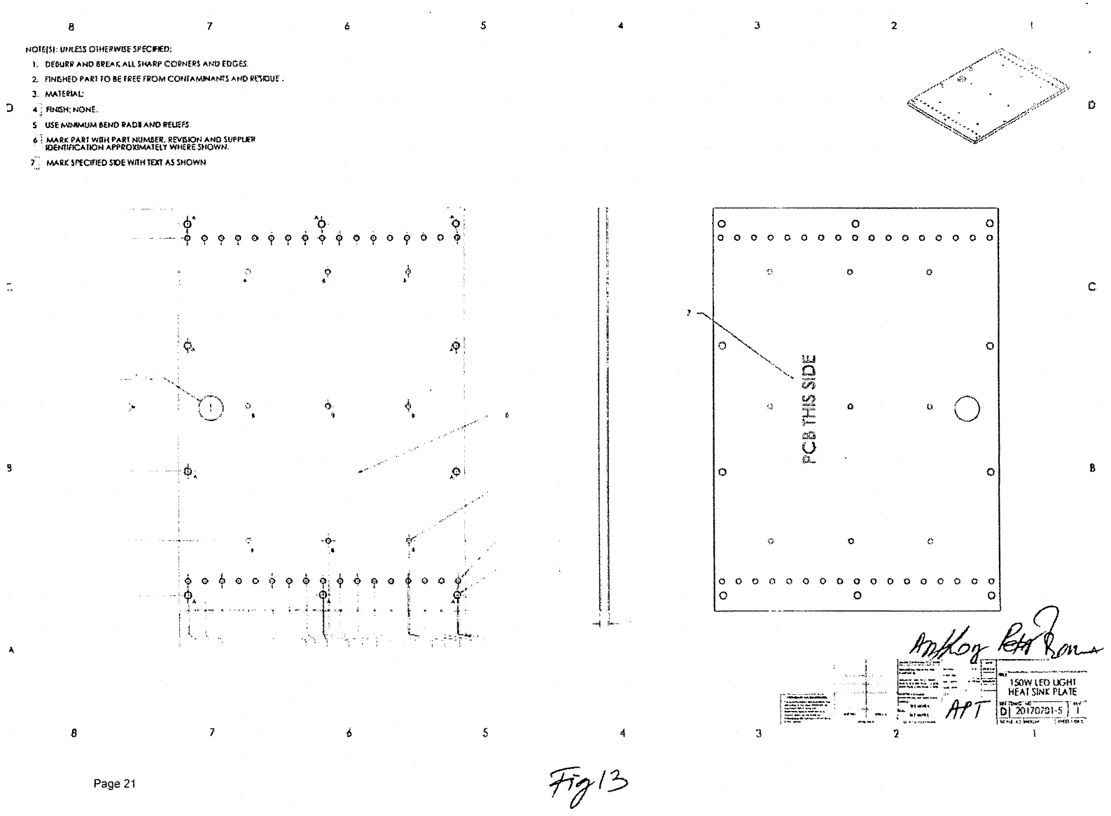

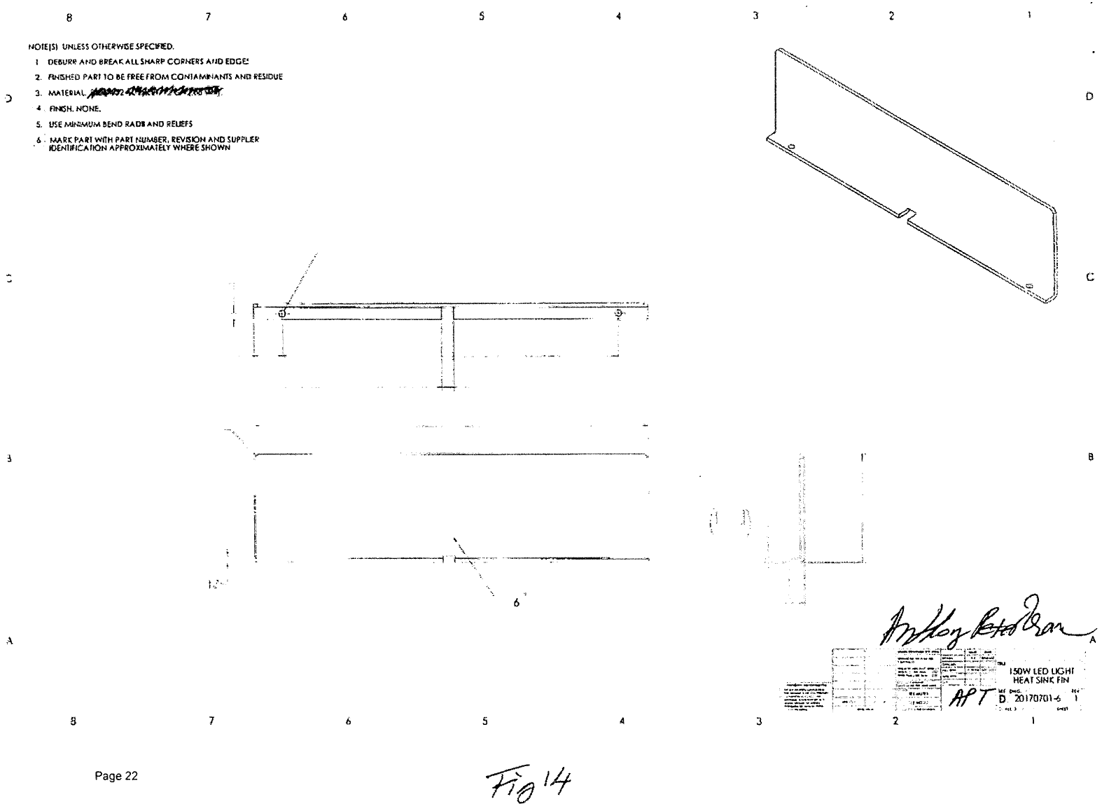

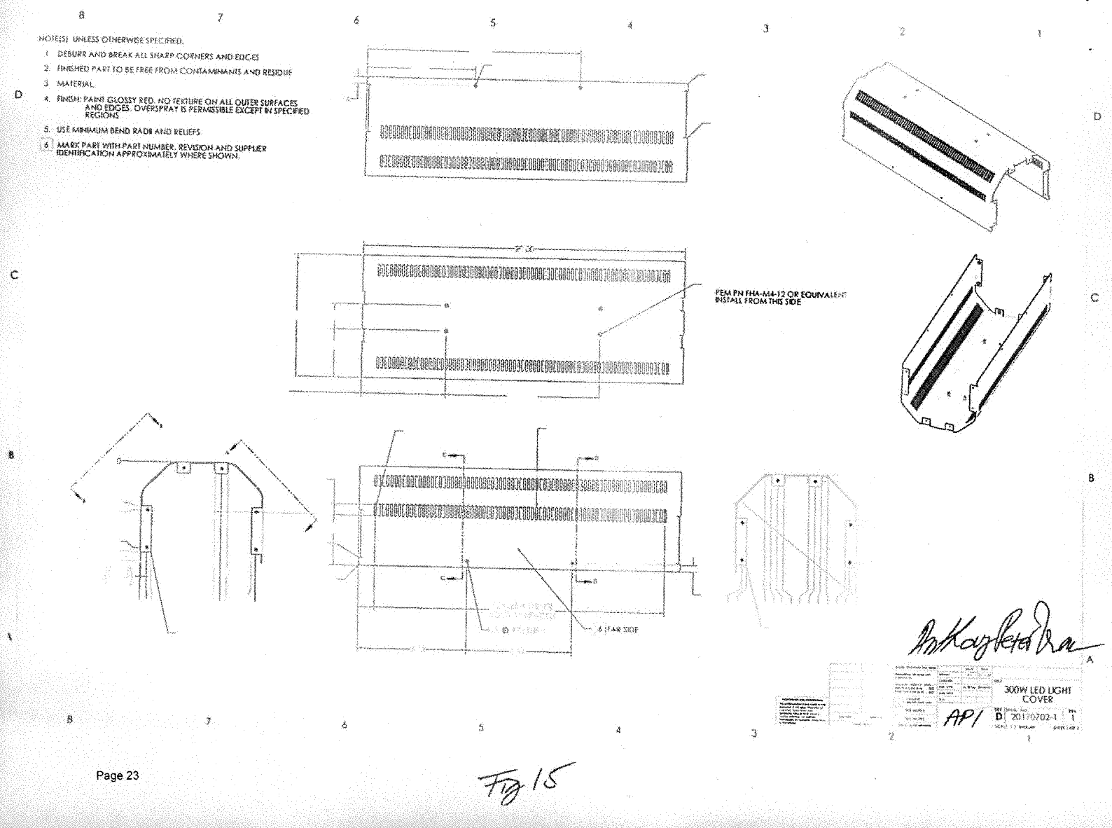

iv. Heat Sink use sheet metal aluminum technology to build a heat sink (FIG. 12): Heat sink plate (FIG. 13) and heat sink fin (FIG. 14)

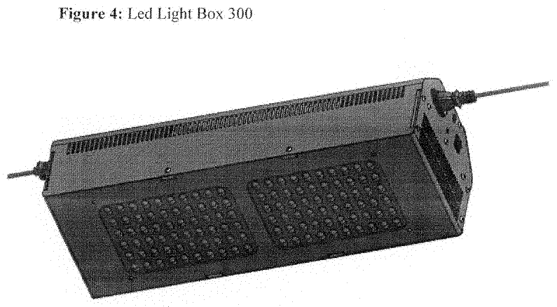

### Led Light Box 300 w Mechanical Draw (FIG. 4).

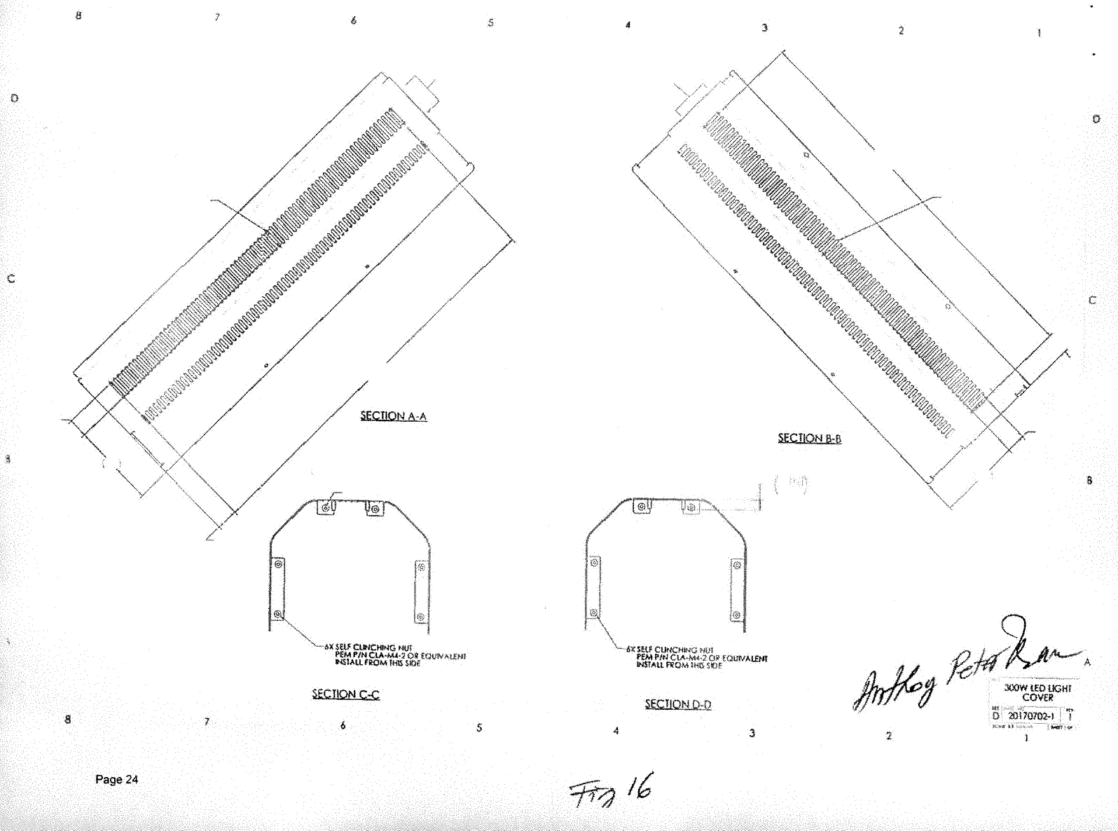

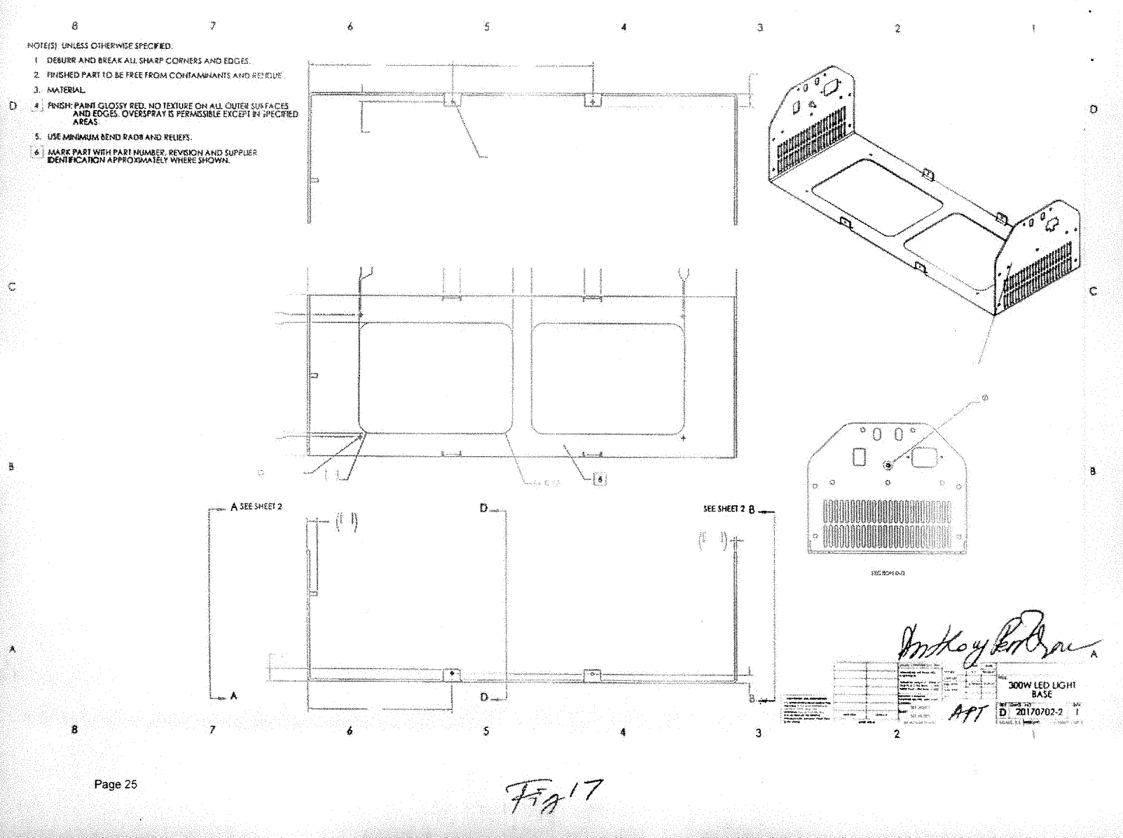

i. Light cover FIG. 15 and FIG. 16

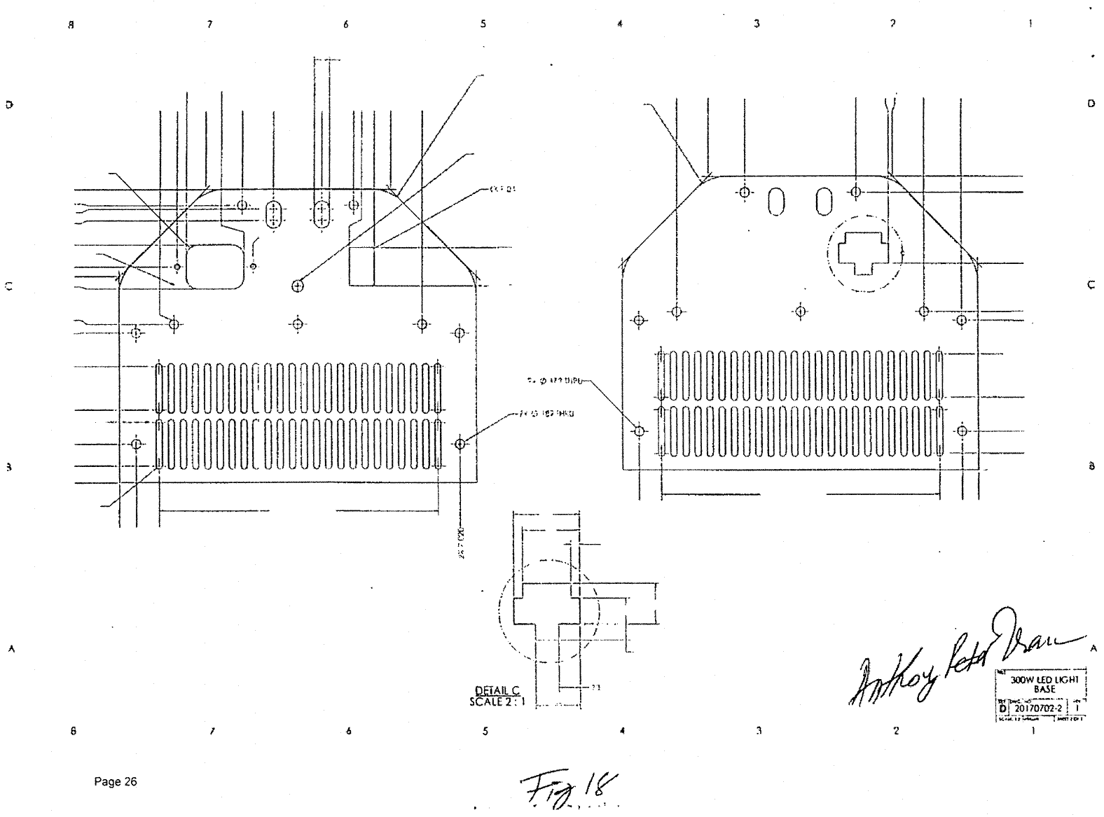

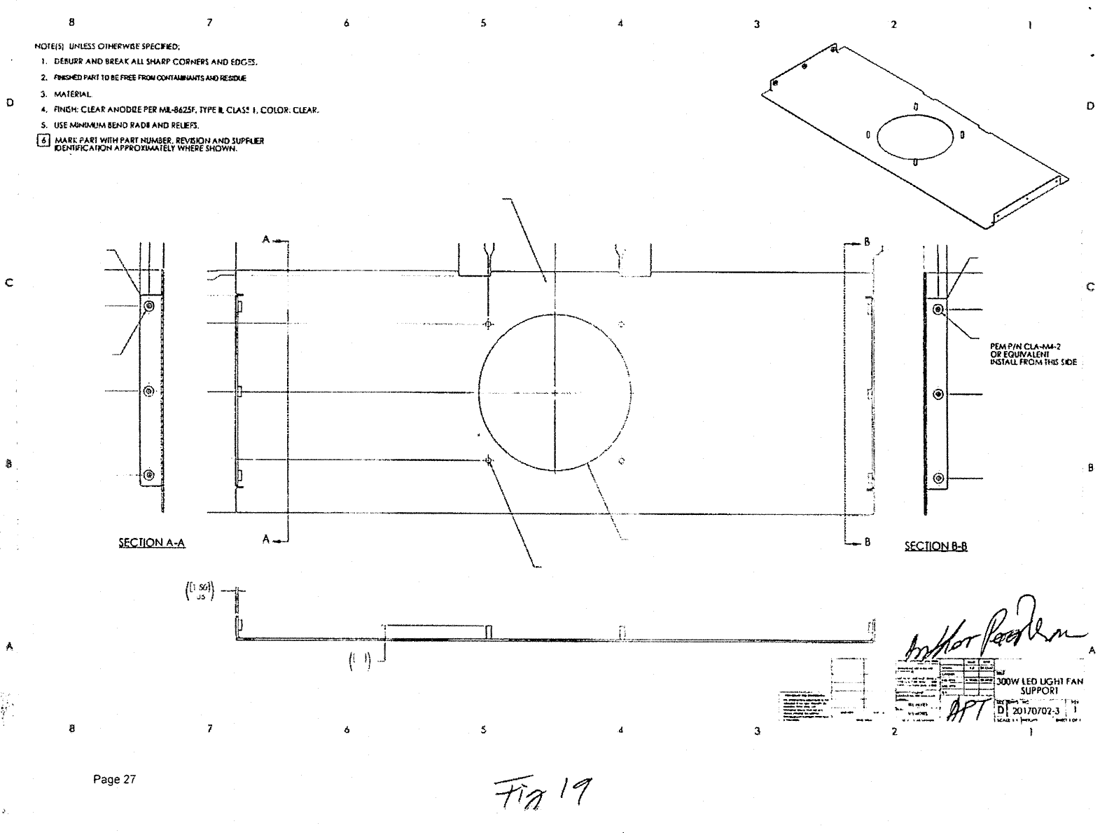

ii. Light Base FIG. 17 and FIG. 18

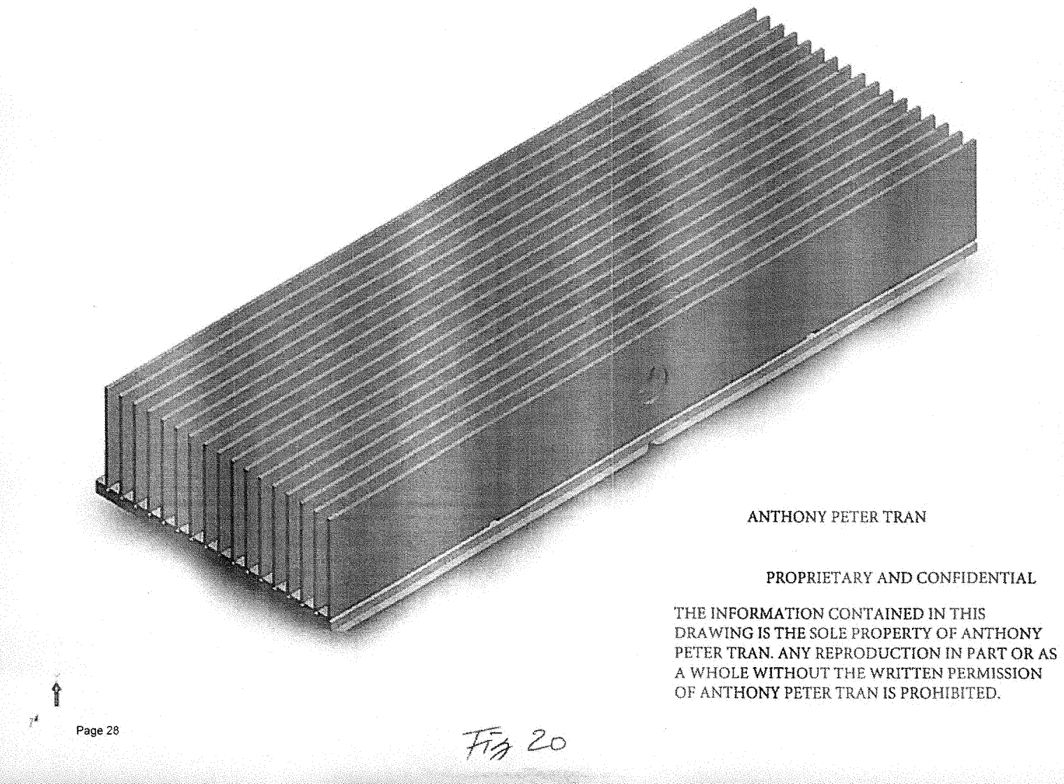

iii. Fan Cover or Fan Support. FIG. 19

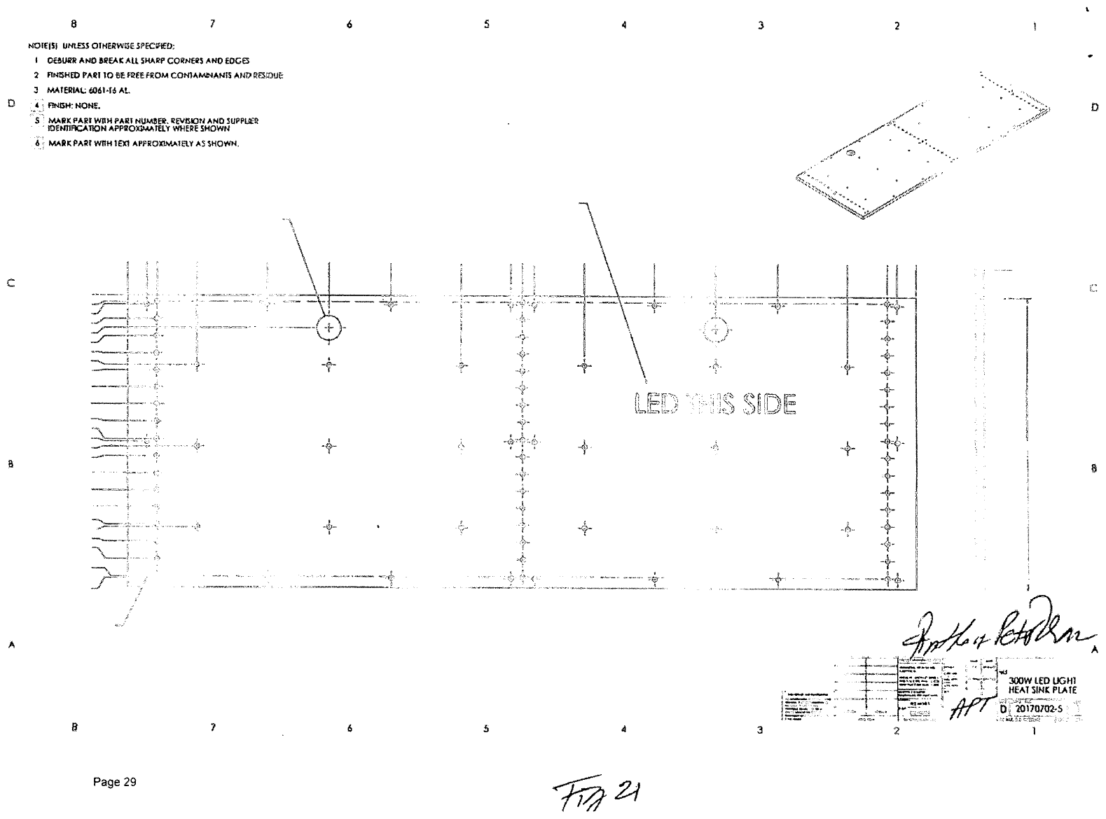

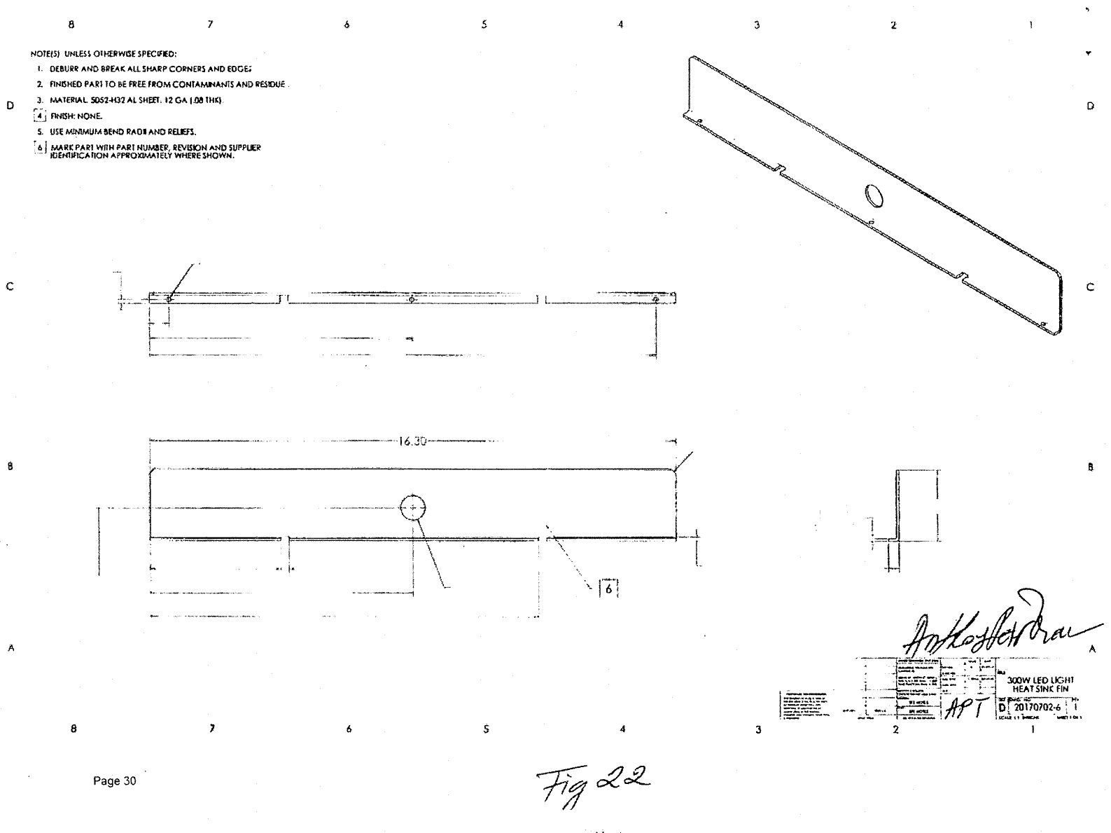

iv. Heat Sink use Sheet Metal Aluminum Technology to Build a Heat Sink (FIG. 20): Heat sink plate (FIG. 21) and heat sink fin (FIG. 22).

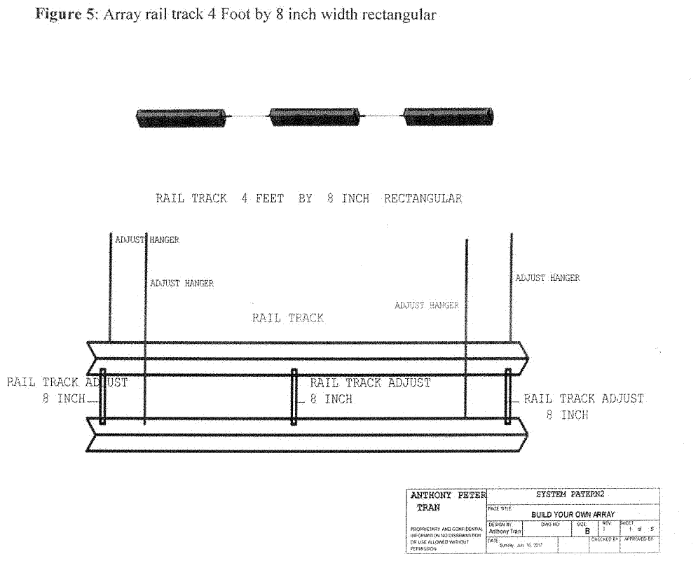

### Array Rail Track 4 Foot by 8 Inch Width Rectangular Examples (FIG. 5).

The rail track can connected to 8 foot or 12 etc and can adjust the width from 8 inch, 7, 6 in vertical ec. . . .

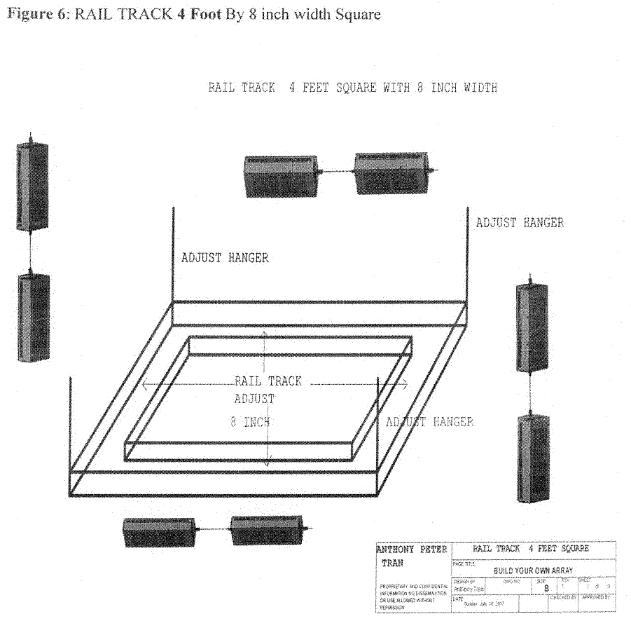

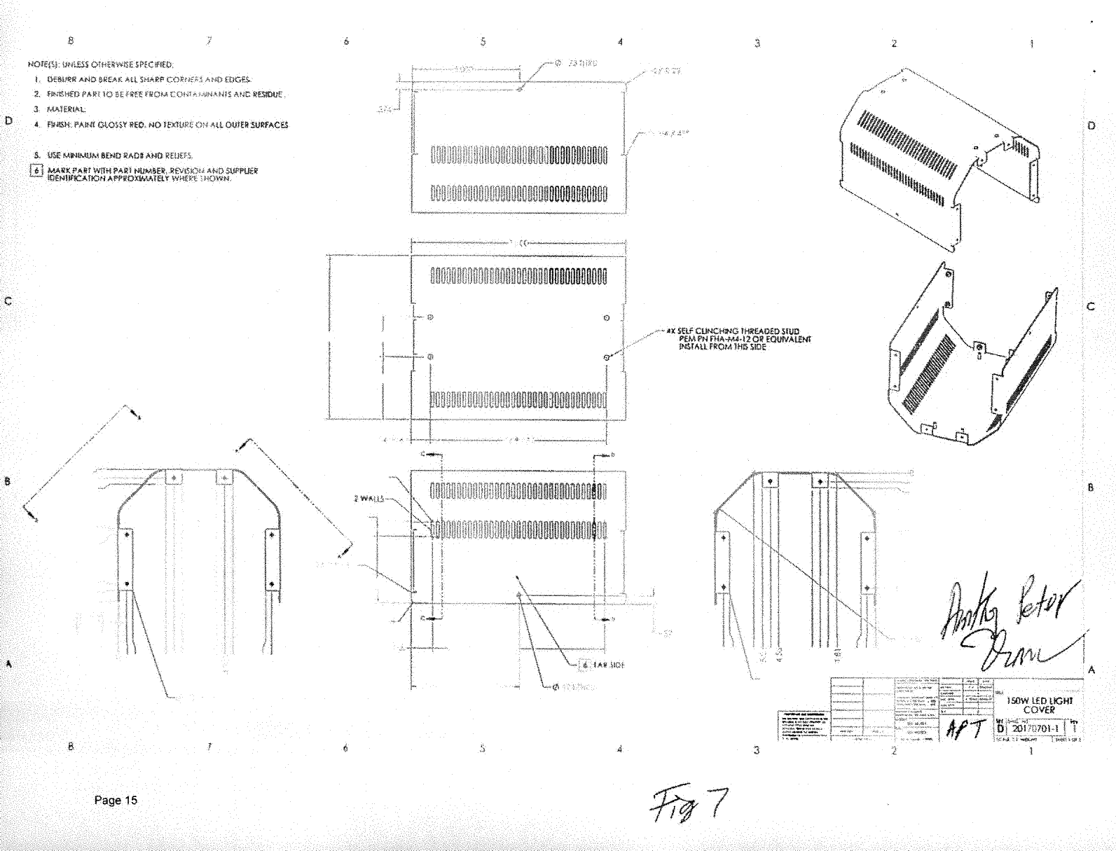

### Array Rail Track 4 Foot by 8 Inch Width Square Examples (FIG. 6).

The rail track can connected to 8 foot or 12 foot Square etc and can adjust the width from 8 inch, 7, 6 vertical or horizontal ect. . . .

1. a. The arrays can be daisy chained and controlled with a master/slave wavelength controllers.
b. Specially designed heat sink with adjustable removable slates.
